(19) United States
(12) Patent Application Publication
(10) Pub. No.: US 2006/0043659 A1
(43) Pub. Date: Mar. 2, 2006

(54) Dual spring jounce bumper assembly

(76) Inventors: Marian Gofron, Ann Arbor, MI (US); Joseph A. Schudt, Macomb, MI (US); Stephen I. Walker, Grosse Pointe Park, MI (US); Robert Louis Geisler, Grand Blanc, MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 10/929,351

(22) Filed: Aug. 30, 2004

(51) Int. Cl. B60G 13/00

(52) U.S. Cl. 267/220

(57) ABSTRACT

A dual spring jounce bumper assembly for a vehicle includes a jounce bumper adapted to be mounted in the suspension system and a spring disposed in series with the jounce bumper to reduce jounce bumper rate progressivity and peak loads in the jounce bumper.

### TECHNICAL FIELD

The present invention relates generally to suspension systems for vehicles and, more particularly, to a dual spring jounce bumper assembly for a suspension system of a vehicle.

### BACKGROUND OF THE INVENTION

It is known to provide a suspension system for a vehicle such as a motor vehicle. One form of the suspension system includes a coil spring seated in a lower seat in a wheel assembly and seated in an upper seat in a vehicle body or frame of the vehicle. The spring supports the weight of the vehicle and allows for reciprocating relative movement between a vehicle wheel and vehicle during road travel to isolate wheel disturbances from the vehicle body. Typically, a form of stop is provided between the vehicle wheel or axle and the vehicle body to limit travel of the wheel in the direction of the body and to prevent a metal surface of the wheel or axle from “bottoming out” against the vehicle body. These stops are typically made of rubber or plastic urethane foam and are referred to as jounce bumpers.

In another form of the suspension system, a strut is mounted between a vehicle chassis and a vehicle body of the vehicle. The strut typically includes a hydraulic cylinder with an attached piston and piston rod. The piston rod slidably extends from an upper end of the hydraulic cylinder and is connected to the vehicle body through a flexible connection. The hydraulic cylinder is attached to the vehicle chassis at its lower end. The impact of shocks from a road surface causes movement of the piston through fluid contained in the hydraulic cylinder. The resistance of movement of the piston through the hydraulic cylinder is dependent on the rate of displacement, thereby damping the movement of the associated spring and preventing excessive bouncing.

As the wheel assembly of the vehicle encounters road inputs, the suspension system undergoes compression (jounce) and extension (rebound) strokes. During a large magnitude suspension event, such as the vehicle wheel running over an object in the road or traveling through a series of potholes, the jounce bumper may contact a stop in the vehicle body and elastically deform responsive to the force of the contact of the jounce bumper against the vehicle body. As elastic deformation increases, the force provided by the bumper also increases, increasing to a limit at which the bumper stops the relative movement of the wheel assembly toward the vehicle body.

In a strut type suspension system, the strut is provided with the jounce bumper to protect the strut and the vehicle body from extreme jounce forces associated with irregularities in the road surface. The jounce bumper may be mounted axially on the piston rod. Jounce bumpers are commonly made from soft elastomers (for example, urethane or rubber). Jounce bumpers may be convoluted in shape in order to (a) reduce the initial stiffness during contact and (b) allow for a longer, and as a result, potentially more load efficient, bumper to be packaged.

At a large compression, a highly progressive nonlinear stiffness rate is developed by the jounce bumper. This is undesirable for loads management and gives rise to high peak strut loads, particularly as a result of potholes in the road surface. These high peak loads may limit wheel size and unsprung mass, both of which can result in increases in the load that passes through the jounce bumper, all else being equal. Otherwise, increased unsprung mass and wheel size could require costly structural reinforcements to the strut upper mount vehicle structure. Standard jounce bumpers can also generate undesirable ride characteristics as a result of their highly progressive rates. The response of the vehicle suspension system to a very stiff or progressive rate is often characterized as harsh or lacking in good energy management.

As a result, it is desirable to provide a new jounce bumper assembly for a suspension system of a vehicle in which a secondary jounce bumper is provided to reduce the highly progressive nonlinear stiffness exhibited by a standard elastomeric jounce bumper. It is also desirable to provide a jounce bumper assembly for a suspension system of a vehicle that limits high peak loads in a jounce bumper. It is further desirable to provide a jounce bumper assembly for a suspension system of a vehicle that provides a low cost—both in terms of piece cost and required modifications to other components—solution for greatly enhancing peak load performance of a jounce bumper. Therefore, there is a need in the art to provide a jounce bumper assembly for a suspension system of a vehicle that meets these desires.

### SUMMARY OF THE INVENTION

It is, therefore, one object of the present invention to provide a new jounce bumper assembly for a suspension system of a vehicle.

It is another object of the present invention to provide a jounce bumper assembly that reduces a progressive nonlinear rate character of a jounce bumper.

It is yet another object of the present invention to provide a jounce bumper assembly for a suspension system of a vehicle that reduces high peak loads in a jounce bumper.

To achieve the foregoing objects, the present invention is a dual spring jounce bumper assembly for a suspension system of a vehicle. The dual spring jounce bumper assembly includes a jounce bumper adapted to be mounted in the suspension system and a spring disposed in series with the jounce bumper to reduce jounce bumper rate progressivity and peak loads in the jounce bumper.

The secondary spring of the present invention is intended to have a high stiffness when compared to the undeformed jounce bumper but a relatively comparable or lower stiffness at large amounts of compression for the bumper. The spring may thusly be constructed of a different material from the elastomeric bumper (e.g., metal, rubber, or hard plastic).

One advantage of the present invention is that a dual spring jounce bumper assembly is provided for a suspension system of a vehicle to greatly enhance peak load performance of a jounce bumper by reducing the peak loads the jounce bumper generates. Another advantage of the present invention is that the dual spring jounce bumper assembly reduces the progressive nonlinear character of a jounce bumper offering potential ride improvements. Yet another advantage of the present invention is that the dual spring jounce bumper assembly provides a low cost solution for substantially improving the ability of jounce bumpers to reduce peak loads. Still another advantage of the present invention is that the dual spring jounce bumper assembly provides significant improvement of ride quality, stability, and reliability of the vehicle. A further advantage of the present invention is that the dual spring jounce bumper assembly provides a savings on vehicle weight and decreases the unsprung mass. Yet a further advantage of the present invention is that the dual spring jounce bumper assembly is very reliable and durable and provides significantly smaller loads acting on the vehicle body.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a fragmentary elevational view of a dual spring jounce bumper assembly, according to the present invention, illustrated in operational relationship with a vehicle.

FIG. 2 is an enlarged fragmentary view of another embodiment, according to the present invention, of the dual spring jounce bumper assembly of FIG. 1.

FIG. 3 is an enlarged fragmentary view of yet another embodiment, according to the present invention, of the dual spring jounce bumper assembly of FIG. 1.

FIG. 4 is a fragmentary elevational view of still another embodiment, according to the present invention, of the dual spring jounce bumper assembly illustrated in operational relationship with a vehicle.

FIG. 5 is an enlarged fragmentary view of the dual spring jounce bumper assembly of FIG. 4.

FIG. 6 is an enlarged fragmentary view of a further embodiment, according to the present invention, of the dual spring jounce bumper assembly of FIG. 4.

FIG. 7 is a graph of force versus compression of the dual spring jounce bumper assembly of FIGS. 4 through 6.

### DESCRIPTION OF THE PREFERRED EMBODIMENT

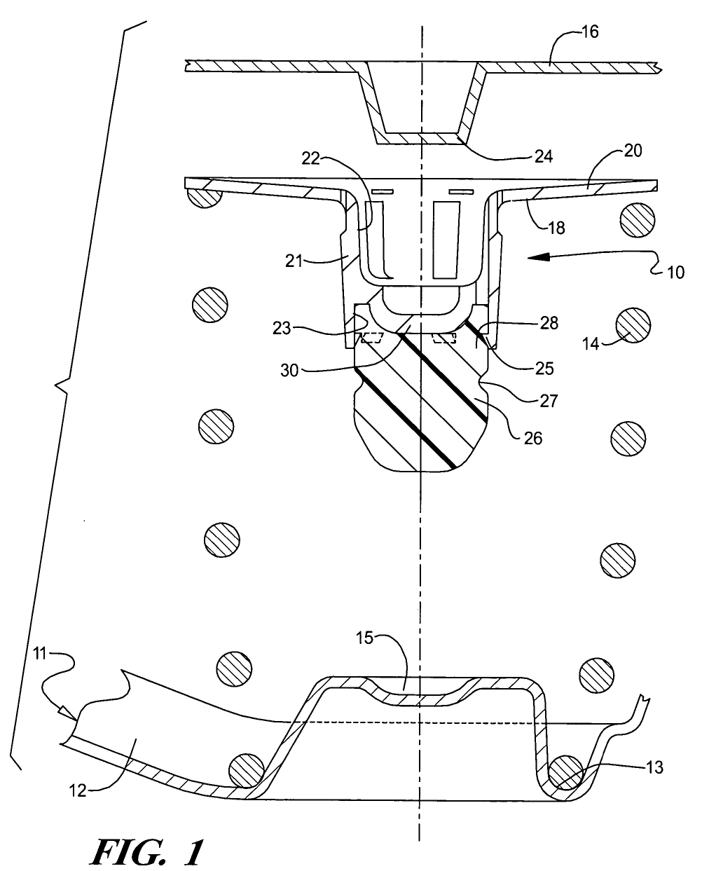

Referring to the drawings and in particular FIG. 1, one embodiment of a dual spring jounce bumper assembly 10, according to the present invention, is shown for a suspension system, generally indicated at 11, of a vehicle (not shown). The suspension system 11 is operatively connected between an unsprung portion (not shown) and a sprung portion (not shown) of the vehicle in a well-known manner.

The suspension system 11 includes a lower control arm 12 having a spring seat 13. The suspension system 11 includes a coil spring 14 having a lower end that rests in the spring seat 13. The suspension system 11 includes a bumper stop 15 radially inward of the spring seat 13 against which the jounce bumper assembly 10 contacts during full contraction of the suspension system 11. The suspension system 11 includes an upper spring seat 16 against which the dual spring jounce bumper assembly 10 sits. It should be appreciated that, except for the dual spring jounce bumper assembly 10, the suspension system 11 is conventional and known in the art.

The dual spring jounce bumper assembly 10 includes a retainer or jounce bumper cup 18 against which an upper portion of the spring 14 sits to isolate high frequency noise in the spring 14 from traveling to the vehicle body via the upper spring seat 16. The jounce bumper cup 18 has a radially extending base portion 20 and an axially extending cup portion 21 with a cavity 22 extending axially therein that sits over an axially extending projection 24 of the upper spring seat 16 in a known manner. The jounce bumper cup 18 includes a recess 23 extending axially into the cup portion 21 opposite the cavity 22 to receive a portion of a jounce bumper 26 to be described. The cup portion 21 also has a plurality of flange portions 25 spaced circumferentially and extending radially into the recess 23. The jounce bumper cup 18 is made of a plastic material. The jounce bumper cup 18 is a monolithic structure being integral, unitary, and one-piece.

The jounce bumper 26 is in series with the jounce bumper cup 18. The jounce bumper 26 is generally cylindrical in shape with at least one convolution 27. The jounce bumper 26 includes an annular recess 28 to receive the flanges 25 of the jounce bumper cup 18. The jounce bumper 26 is formed from a compressible foam such as urethane or an elastomeric material such as rubber. It should be appreciated that the jounce bumper 26 is secured to the jounce bumper cup 18 by the flanges 25 being disposed in the recess 28.

The dual spring jounce bumper assembly 10 also includes at least one high rate spring 30 disposed in series with the jounce bumper 26. The spring 30 is a generally “U” shaped portion of the jounce bumper cup 18. The spring 30 extends radially from the cup portion 21 and axially into the recess 23. In the embodiment illustrated, the spring 30 is integral, unitary, and one-piece with the jounce bumper cup 18. It should be appreciated that the spring 30 offsets the rate of the jounce bumper 26 at high compression and thus provides for better energy consumption.

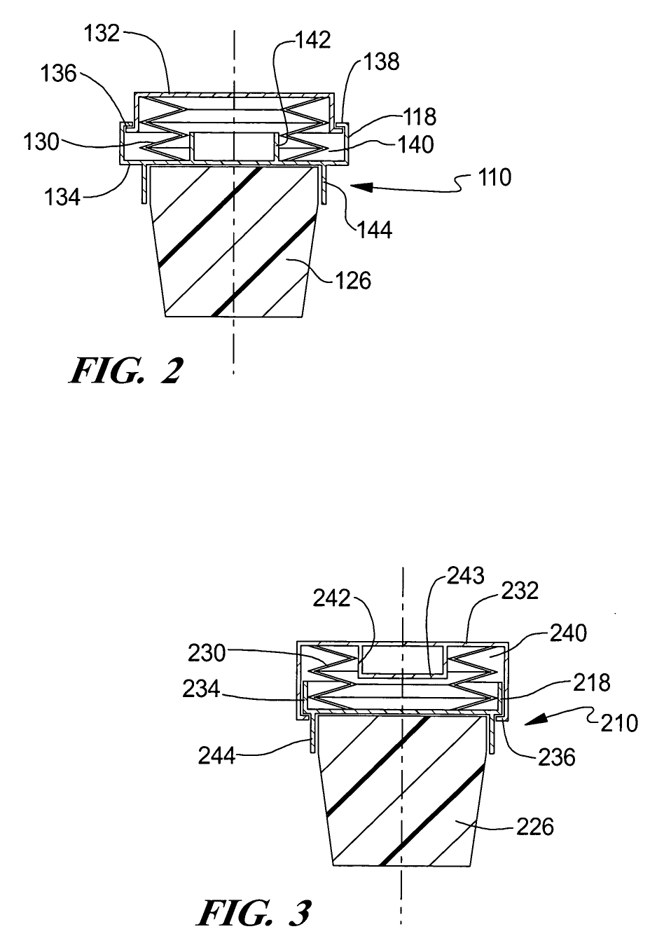

Referring to FIG. 2, another embodiment, according to the present invention, of the dual spring jounce bumper assembly 10 is shown. Like parts of the dual spring jounce bumper assembly 10 have like reference numerals increased by one hundred (100). In this embodiment, the dual spring jounce bumper assembly 110 includes the jounce bumper 126 and jounce bumper cup 118. The jounce bumper 126 is generally frusto-conical in shape. The jounce bumper cup 118 is in two-pieces of a first or upper member 132 and a second or lower member 134. The first member 132 is generally annular and “U” shaped with a flange 136 extending radially outward. The second member 134 is generally annular and “U” shaped with a flange 138 extending radially inward. The second member 134 is disposed over the first member 132 such that the flanges 136 and 138 cooperate together and form a cavity 140. The second member 134 also includes an annular spring guide 142 extending axially into the cavity 140 and toward the first member 132. The second member 134 also includes an annular bumper saddle 144 extending axially away from the cavity 140 and toward the jounce bumper 126. A portion of the jounce bumper 126 is disposed in the bumper saddle 144. The dual spring jounce bumper assembly 110 also includes the spring 130 disposed within the cavity 140 between the first member 132 and second member 134. The spring 130 is a plurality of pre-compressed elastic members such as washers. It should be appreciated that the second member 134 moves axially relative to the first member 132 and the flange 138 acts as an upper stop and the second member 134 acts as a lower stop during operation.

Referring to FIG. 3, yet another embodiment, according to the present invention, of the dual spring jounce bumper assembly 10 is shown. Like parts of the dual spring jounce bumper assembly 10 have like reference numerals increased by two hundred (200). In this embodiment, the dual spring jounce bumper assembly 210 includes the jounce bumper 226 and the jounce bumper cup 218. The jounce bumper 226 is generally frusto-conical in shape. The jounce bumper cup 218 is in two-pieces of a first or upper member 232 and a second or lower member 234. The first member 232 is generally annular and “U” shaped with a flange 236 extending radially inward. The second member 234 is generally annular and “U” shaped. The second member 234 is disposed inside the first member 232 such that the flange 236 retains the first member 234 and to form a cavity 240. The first member 232 also includes an annular spring guide 242 extending axially into the cavity 240 and toward the second member 234 and having a flange 243 extending radially inward. The second member 234 also includes an annular bumper saddle 244 extending axially away from the cavity 240 and toward the jounce bumper 226. A portion of the jounce bumper 226 is disposed in the bumper saddle 244. The dual spring jounce bumper assembly 210 also includes the spring 230 disposed within the cavity 240 between the first member 232 and second member 234. The spring 230 is a plurality of pre-compressed elastic members such as washers. It should be appreciated that the second member 234 moves axially relative to the first member 232 and the flange 236 acts as an upper stop and the flange 243 acts as a lower stop during operation.

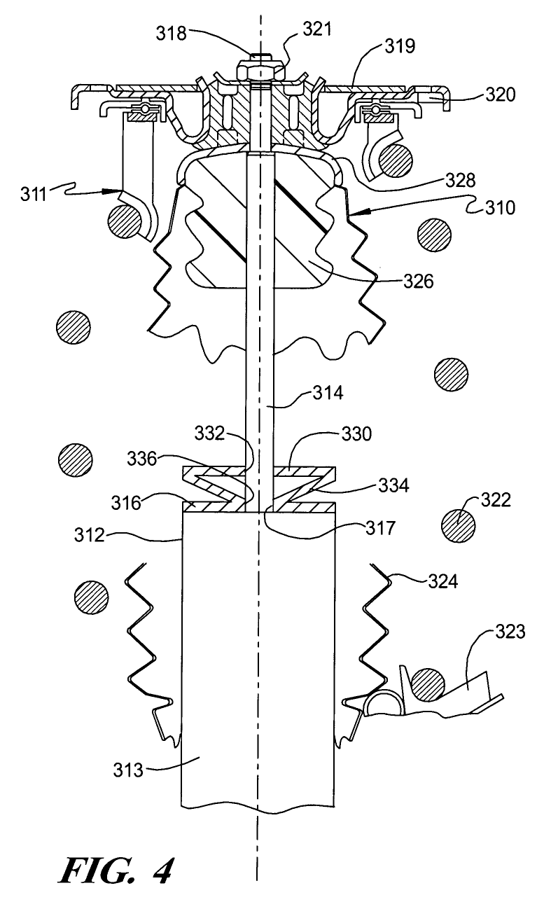

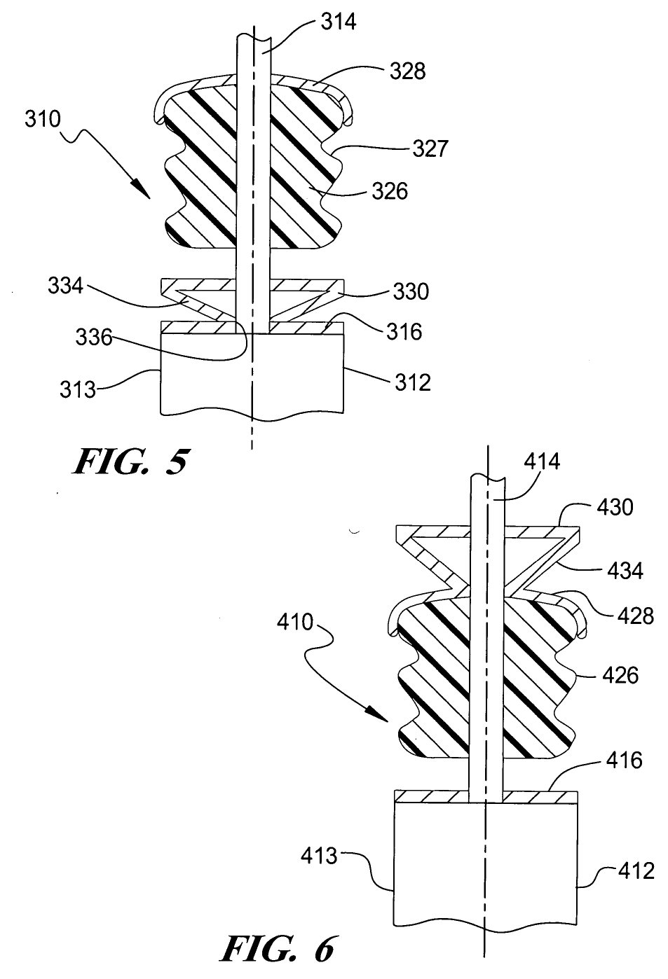

Referring to FIGS. 4 and 5, still another embodiment, according to the present invention, of the jounce bumper assembly 10 is shown for a suspension system, generally indicated at 311, of a vehicle (not shown). The suspension system 311 is operatively connected between an unsprung portion (not shown) and a sprung portion (not shown) of the vehicle in a well-known manner.

The suspension system 311 includes a hydraulic cylinder 312 having a reservoir tube 313 that provides a reservoir for hydraulic damping fluid. The hydraulic cylinder 312 also includes a cylindrical piston rod 314 extending along a central axis of the reservoir tube 313 and is attached at one end to a conventional valved piston (not shown) slidably mounted in a cylindrical inner tube (not shown) concentric with and spaced inwardly from the reservoir tube 313. The hydraulic cylinder 312 includes a seal cover 316, welded or otherwise secured to the reservoir tube 313, to close the upper end of the reservoir tube 313. The piston rod 314, which extends upwardly through an opening 317 in the seal cover 316, has a reduced diameter threaded portion 318. The suspension system 311 also includes an upper support housing 319 to attach the hydraulic cylinder 312 to a frame (not shown) of the vehicle by suitable means such as by insertion of frame bolts 320 through corresponding openings in the frame. The piston rod 314 is attached to the upper support housing 319 by suitable means such as a threadable connection of nut 321 secured to the threaded portion 318 extending through the upper support housing 319.

The suspension system 311 also includes a coil spring 322 mounted between the upper support housing 319 and a lower support housing 323 (partially shown). The suspension system 311 further includes an elastomeric boot 324 that encloses the upper portion of the hydraulic cylinder 312. The boot 324 is mounted within the spring 322 and is secured to the upper support housing 319 and the lower support housing 323. It should be appreciated that, except for the dual spring jounce bumper assembly 310, the suspension system 311 is conventional and known in the art.

Referring to FIGS. 4 and 5, the dual spring jounce bumper assembly 310 includes a jounce bumper 326 mounted on the piston rod 314. The jounce bumper 326 is generally cylindrical in shape with at least one convolution 327. The jounce bumper 326 is formed from a compressible foam such as urethane or an elastomeric material such as rubber. The dual spring jounce bumper assembly 310 also includes a jounce bumper cup 328 mounted on the piston rod 314 and secured to the upper mount assembly 319. It should be appreciated that the jounce bumper 326 is secured to the jounce bumper cup 328 by suitable means such as an interference fit.

The dual spring jounce bumper assembly 310 also includes a jounce bumper striker cap 330 mounted to the cylinder 312 and located about the piston rod 314 between the seal cover 316 and the jounce bumper 326. The jounce bumper striker cap 330 is generally configured as an annular disc having a central bore 332 shaped to receive the piston rod 314. It should be appreciated that the piston rod 314 moves relative to the striker cap 330.

The dual spring jounce bumper assembly 310 also includes at least one high rate spring 334 disposed in series with the jounce bumper 326. The spring 334 is generally configured as a Belleville-type spring in one embodiment. In another embodiment, the spring 334 is configured as a rubber or urethane secondary bumper. The spring 334 is generally annular in shape and has a central bore 336 shaped to receive the piston rod 314. In the embodiment illustrated, the spring 334, striker cap 330, and seal cover 316 are integral and one-piece and the spring 334 is located about the piston rod 314 between the seal cover 316 and the jounce bumper striker cap 330.

Referring to FIG. 6, a further embodiment, according to the present invention, of the dual spring jounce bumper assembly 310 is shown. Like parts of the dual spring jounce bumper assembly 310 have like reference numerals increased by one hundred (100). In this embodiment, the dual spring jounce bumper assembly 410 includes the jounce bumper 426, jounce bumper cup 428, and jounce bumper striker cap 430. The dual spring jounce bumper assembly 410 also includes the spring 434 disposed behind or above the jounce bumper cup 428. In the embodiment illustrated, the spring 434, striker cap 430, and jounce bumper cup 428 are integral and one-piece and secured to the piston rod 14 by suitable means such as a retention device or welding. It should be appreciated that the jounce bumper assembly 410 is a flexible cup that generates the secondary rate through intentional structural design as shown on the rear suspension bumper.

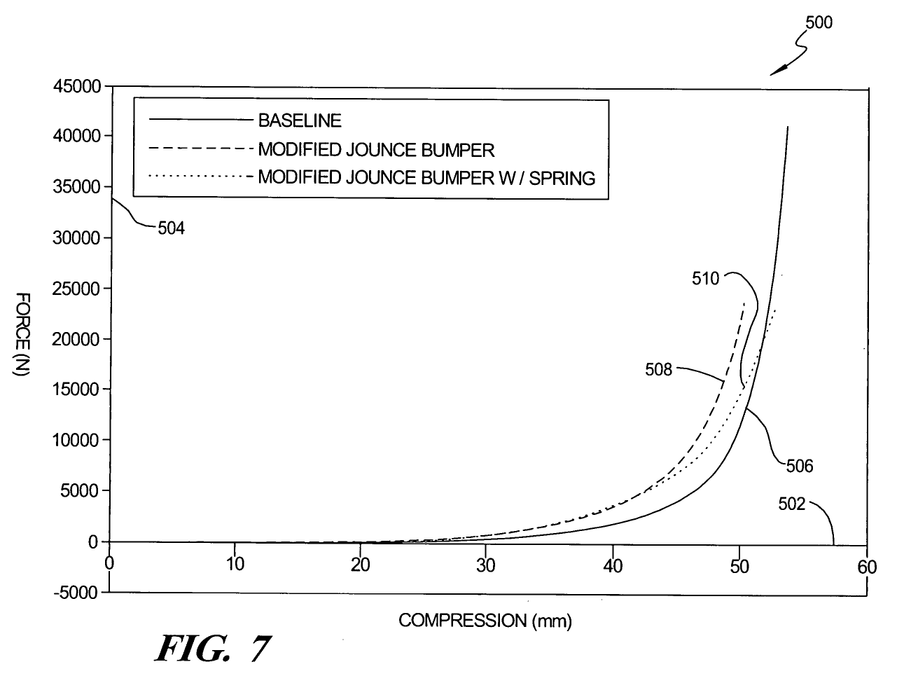

Referring to FIG. 7, a graph 500 is shown for the dual spring jounce bumper assembly 310,410. The graph 500 includes an x-axis 502 of compression in millimeters (mm) and a y-axis 504 of force in Newtons (N). The graph 500 includes a jounce bumper load/deflection curve 506 in solid lines for a conventional or baseline urethane jounce bumper. The graph 500 includes a jounce bumper load/deflection curve 508 in dashed lines for the modified or jounce bumper 326,426. The graph 500 includes a jounce bumper load/deflection curve 510 in dotted lines for the modified or jounce bumper 326,426 and the spring 334,434. It should be appreciated that there is a substantial reduction in peak load for equivalent energy absorption and jounce bumper compression between the dual spring jounce bumper assembly 310,410 and the baseline or conventional jounce bumper.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A dual spring jounce bumper assembly for a suspension system of a vehicle comprising:
a jounce bumper adapted to be mounted in the suspension system; and
a spring disposed in series with said jounce bumper to reduce jounce bumper rate progressivity and peak loads in said jounce bumper.

2. A dual spring jounce bumper assembly as set forth in claim 1 including a jounce bumper cup to receive and retain said jounce bumper.

3. A dual spring jounce bumper assembly as set forth in claim 2 wherein said jounce bumper cup comprises a first member and a second member having a cavity therebetween.

4. A dual spring jounce bumper assembly as set forth in claim 3 wherein said spring is disposed in said cavity between said first member and said second member.

5. A dual spring jounce bumper assembly as set forth in claim 3 wherein said spring comprises a plurality of pre-compressed elastic members.

6. A dual spring jounce bumper assembly as set forth in claim 3 wherein said jounce bumper cup includes a spring guide disposed in said cavity to guide said movement of said spring.

7. A dual spring jounce bumper assembly as set forth in claim 2 wherein said jounce bumper cup comprises a base portion extending radially and a cup portion extending axially from said base portion.

8. A dual spring jounce bumper assembly as set forth in claim 7 wherein said cup portion has a recess to receive a portion of said jounce bumper.

9. A dual spring jounce bumper assembly as set forth in claim 8 wherein said spring extends radially from said cup portion and axially into said recess.

10. A dual spring jounce bumper assembly as set forth in claim 1 wherein said cup portion and said spring are integral and one-piece.

11. A dual spring jounce bumper assembly for a suspension system of a vehicle comprising:
a jounce bumper adapted to be mounted about a piston rod of a hydraulic cylinder; and
a spring disposed in series with said jounce bumper to reduce jounce bumper rate progressivity and peak loads in said jounce bumper.

12. A dual spring jounce bumper assembly as set forth in claim 11 wherein said spring is adapted to be mounted to the piston rod.

13. A dual spring jounce bumper assembly as set forth in claim 11 including a striker cap adapted to be mounted to the piston rod.

14. A dual spring jounce bumper assembly as set forth in claim 13 wherein said striker cap is spaced from a tube of the hydraulic cylinder.

15. A dual spring jounce bumper assembly as set forth in claim 23 wherein said striker cap is operatively supported by a tube of the hydraulic cylinder.

16. A dual spring jounce bumper assembly as set forth in claim 11 wherein said spring is adapted to be mounted to the piston rod and disposed between said striker cap and the hydraulic cylinder.

17. A dual spring jounce bumper assembly as set forth in claim 11 including a jounce bumper cup adapted to be mounted to the piston rod.

18. A dual spring jounce bumper assembly as set forth in claim 17 wherein said jounce bumper is disposed within said jounce bumper cup.

19. A dual spring -jounce bumper assembly as set forth in claim 17 wherein said spring is adapted to be mounted to the piston rod and disposed above said jounce bumper cup.

20. A dual spring jounce bumper assembly as set forth in claim 13 wherein said spring and said striker cap are integral and one-piece.
